(19) United States
(12) Patent Application Publication
(10) Pub. No.: US 2011/0131093 A1
(43) Pub. Date: Jun. 2, 2011

(54) SYSTEM AND METHOD FOR OPTIMIZING SELECTION OF ONLINE ADVERTISEMENTS

(75) Inventors: Amir Behroozi, Saratoga, CA (US); Arun Kejariwal, San Jose, CA (US); Sapan Panigrahi, Castro Valley, CA (US)

(73) Assignee: Yahoo! Inc., Sunnyvale, CA (US)

(21) Appl. No.: 12/628,175

(22) Filed: Nov. 30, 2009

(51) Int. Cl. G06Q 30/00; G06F 3/01; G06F 17/30

(52) U.S. Cl. 705/14.52; 705/14.4; 705/14.49; 715/760; 707/723; 707/E17.108

(57) ABSTRACT

An advanced system and method for optimizing selection of online advertisements is provided. Decision trees with expressions to evaluate feature values for advertisements may be received, and a decision tree similarity matrix of decision tree similarity values between pairs of decision trees may be generated that represent the number of common features between two decision trees. The edges of the decision tree similarity matrix may be sorted in non-increasing order by edge value, and the decision trees of each edge retrieved from the sorted order may be placed in an optimized sequence order for evaluation. In response to a request to serve advertisements, advertisements may be scored by evaluating the decision trees of advertisements in the optimized sequence order. The advertisements may then be ranked in descending order by score, and advertisement with the highest scores may be sent for display.

### FIELD OF THE INVENTION

The invention relates generally to computer systems, and more particularly to an improved system and method for optimizing selection of online advertisements.

### BACKGROUND OF THE INVENTION

Sponsored advertising is a widely used mechanism for selling advertisements using Internet search engines. Each time a user enters a search term into a search engine, advertising space may be allocated within that user's search results. For example, a sponsored search advertising area may be used for displaying sponsored advertisements on a search results web page. There are various methods for selling sponsored advertising in online search advertising including keyword auctions where keywords of a user's query may be auctioned to an advertiser who is the highest bidder with sufficient budget. Search engines' revenues from sponsored advertising are currently on the order of ten billion dollars per year.

When a user enters a search term into a search engine, the sponsored advertisements selected for display to the user are based on the initial search terms in the query submitted. Delivering relevant advertisements calls for learning user intent and query understanding in the context of search and semantic advertising. Determining the user intent for delivering relevant advertisements is a difficult problem. For instance, there may be a multitude of possible intents in the context of web search for the query “fly fishing”. It is unclear whether the user is interested in how to fly fish or whether the user is interested in fly patterns, fishing reports or fishing magazines. Often, the user's search intention cannot be directly inferred from the initial search keywords, so sponsored advertisements displayed with the initial search results may not be very relevant without applying techniques to learn a user's intent and to understand a query. Moreover, semantic advertising techniques may be applied to semantically analyze every web page in order to properly understand and classify the meaning of a web page and accordingly ensure that the web page contains the most appropriate advertising. Applying semantic advertising techniques increases the chance that the viewer will click-thru a served advertisement because advertising relevant to what they are viewing, and therefore their inferred interests, should be displayed.

Developing techniques to deliver relevant advertisements relies on applying a multitude of features and metrics derived, for instance, from semantic content, user intent, query understanding, group and community models, and so forth. The multitude of features and metrics may be input into a ranking component of an advertisement selection engine to rank relevant advertisements. Unfortunately, increasing the number of dimensions of features and metrics for evaluating an advertisement's rank incurs higher CPU utilization and increased latency in advertisement selection time. Such increased latency in advertisement selection time limits the use of sophisticated ranking techniques which make use of an increasing number of dimensions of features and metrics for evaluating an advertisement's rank.

What is needed is a way to increase application of advanced ranking techniques for advertisements that may make use of a multitude of features and metrics. Such a system and method should be able to provide more relevant advertisements without increased latency in advertisement selection.

### SUMMARY OF THE INVENTION

Briefly, the present invention may provide a system and method for optimizing selection of online advertisements. In various embodiments, a client computer may be operably connected to a search server and an advertisement server. The advertisement server may be operably coupled to an advertisement serving engine that may include a sequence optimizer that generates an optimized sequence order for evaluating decision trees of sponsored advertisements and a sponsored advertisement selection engine that selects sponsored advertisements scored by evaluating the decision trees of sponsored advertisements in an optimized sequence order. The advertisement serving engine may also include a sponsored advertisement scoring engine that scores sponsored advertisements by evaluating the decision trees of sponsored advertisements in an optimized sequence order. The advertising serving engine may rank sponsored advertisements in descending order by score and send a list of sponsored advertisement with the highest scores to the client computer for display in the sponsored advertisement area of the search results web page. Upon receiving the sponsored advertisements, the client computer may display the sponsored advertisements in the sponsored advertisement area of the search results web page.

In general, the present invention may model advertisement selection as a serial traversal of a set of decision trees used to evaluate feature values of advertisements and may optimize the traversal order of the set of decision trees to score advertisements. To do so, decision trees with expressions to evaluate feature values for advertisements may be received, and a decision tree similarity matrix of decision tree similarity values between pairs of decision trees may be generated that represent the number of common features between two decision trees. To reduce cache misses of feature values, the traversal order of the decision trees may be ordered such that decision trees with high similarity index are placed close to each other in order to enhance reuse of values of features in cache accessed by consecutive decision trees. The edges of the decision tree similarity matrix may be sorted in non-increasing order by edge value, and the decision trees of each edge retrieved from the sorted order may be placed in an optimized sequence order for evaluation, if the decision tree has not yet been placed in the optimized sequence order.

A web browser executing on a client computer may receive a search query input by a user and may send the search query request to a search server. In response, the search server may request a list of sponsored advertisements from the advertisement server to be sent to the web browser executing on the client for display with the search results of query processing. The advertisement server may score a list of sponsored advertisements by evaluating the optimized sequence of decision trees of the list of sponsored advertisements, and the sponsored advertisements may be ranked in descending order by score. A list of sponsored advertisement with the highest scores may be sent to the client computer for display in the sponsored advertisement area of the search results web page.

Upon receiving the update of sponsored advertisements, the client computer may display the updated sponsored advertisements in the sponsored advertisement area of the search results web page.

Advantageously, the present invention may optimize ranking advertisements by exploiting decision tree similarity to improve the run time memory performance for evaluating decision trees to score advertisements. Optimizing the serial traversal order of decision trees may accordingly facilitate deployment of advanced ranking techniques utilizing an increased number of dimensions of features and metrics for evaluating an advertisement's rank to provide more relevant advertisements. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for optimizing selection of online advertisements, in accordance with an aspect of the present invention;

FIG. 3 is an illustration depicting in an embodiment a decision tree for scoring an advertisement, in accordance with an aspect of the present invention;

FIG. 4 is a flowchart generally representing the steps undertaken in one embodiment for determining decision tree similarity, in accordance with an aspect of the present invention;

FIG. 5 is a flowchart generally representing the steps undertaken in one embodiment for generating an optimized sequence order for evaluation of decision trees, in accordance with an aspect of the present invention; and

FIG. 6 is a flowchart generally representing the steps undertaken in one embodiment on an advertisement server for selecting advertisements by evaluating an optimized sequence of decision trees of advertisements to score the advertisements, in accordance with an aspect of the present invention.

### DETAILED DESCRIPTION

### Exemplary Operating Environment

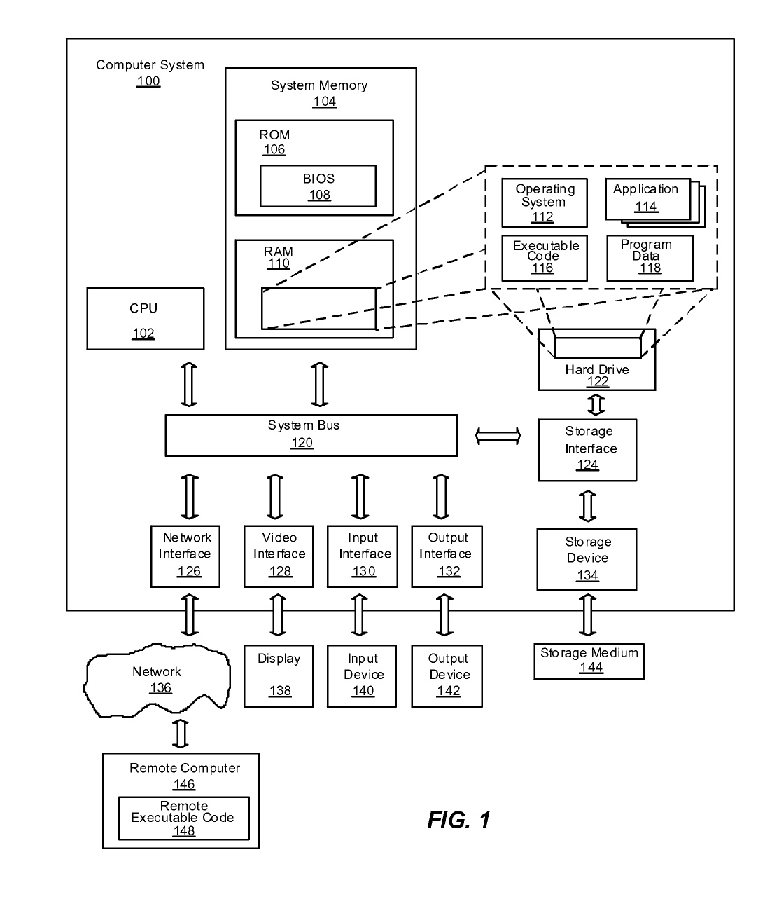

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Optimizing Selection of Online Advertisements

The present invention is generally directed towards a system and method for optimizing selection of online advertisements. In general, the present invention may model advertisement selection as a serial traversal of a set of decision trees used to evaluate feature values of advertisements and may optimize the traversal order of the set of decision trees to score advertisements. As used herein, a decision tree means a decision tree used to evaluate feature values to score an advertisement. A decision tree similarity matrix of decision tree similarity values between pairs of decision trees may be generated that represent the number of common features between two decision trees. The edges of the decision tree similarity matrix may be sorted in non-increasing order by edge value, and the decision trees of each edge retrieved from the sorted order may be placed in an optimized sequence order for evaluation.

As will be seen, advertisements may be scored by evaluating the decision trees of advertisements in the optimized sequence order. The advertisements may then be ranked in descending order by score, and advertisement with the highest scores may be sent for display. In an embodiment, sponsored advertisements displayed in the sponsored advertisement area of a search results web page may be selected by evaluating the decision trees of sponsored advertisements in the optimized sequence order. As used herein, a sponsored advertisement means an advertisement that is promoted typically by financial consideration and includes auctioned advertisements display on a search results web page. As will be understood, the various block diagrams, flow charts and scenarios described herein are only examples, and there are many other scenarios to which the present invention will apply.

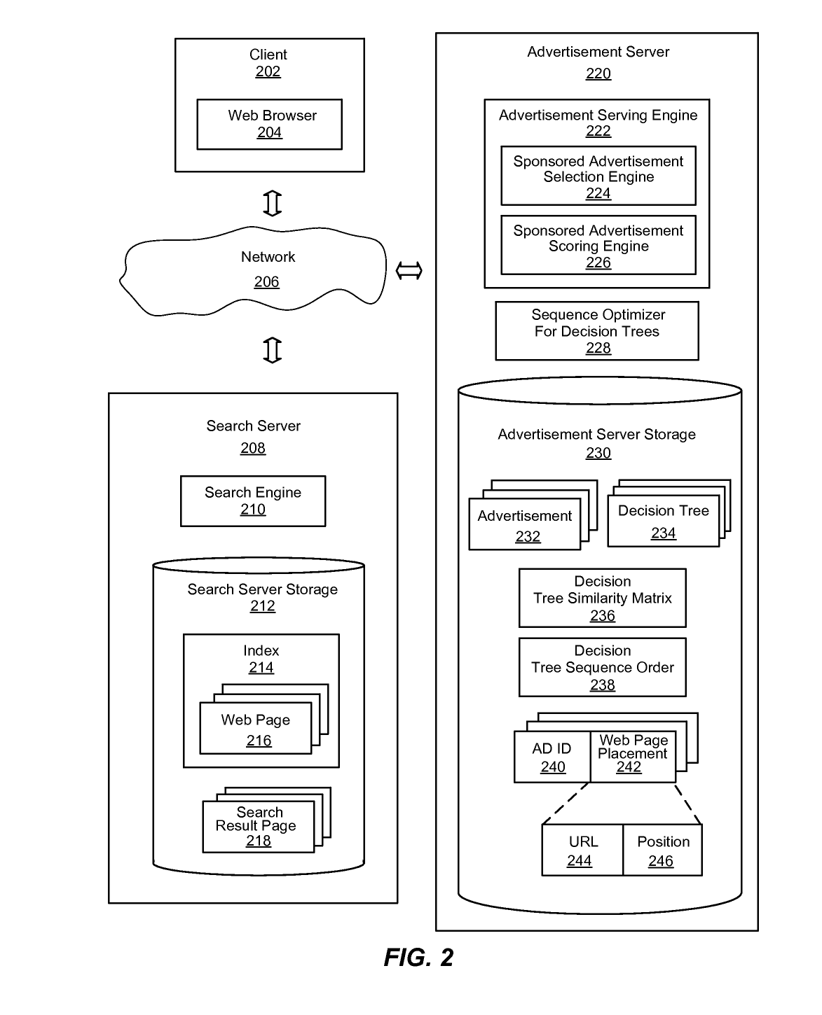

Turning to FIG. 2 of the drawings, there is shown a block diagram generally representing an exemplary architecture of system components for optimizing selection of online advertisements. Those skilled in the art will appreciate that the functionality implemented within the blocks illustrated in the diagram may be implemented as separate components or the functionality of several or all of the blocks may be implemented within a single component. For example, the functionality for the sponsored advertisement scoring engine 226 may be included in the same component as the sponsored advertisement selection engine 224. Or the functionality of the sponsored advertisement scoring engine 226 may be implemented as a separate component from the sponsored advertisement selection engine 224 as shown. Moreover, those skilled in the art will appreciate that the functionality implemented within the blocks illustrated in the diagram may be executed on a single computer or distributed across a plurality of computers for execution.

In various embodiments, a client computer 202 may be operably coupled to a search server 208 and an advertisement server 220 by a network 206. The client computer 202 may be a computer such as computer system 100 of FIG. 1. The network 210 may be any type of network such as a local area network (LAN), a wide area network (WAN), or other type of network. A web browser 204 may execute on the client computer 202 and may include functionality for receiving a search request which may be input by a user entering a query, functionality for sending the query request to a search engine to obtain a list of search results, and functionality for receiving a list of search results from a server for display by the web browser, for instance, in a search results page on the client device. In general, the web browser 204 may be any type of interpreted or executable software code such as a kernel component, an application program, a script, a linked library, an object with methods, and so forth. The web browser 204 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The search server 208 may be any type of computer system or computing device such as computer system 100 of FIG. 1. In general, the search server 208 may provide services for processing a search query and may include services for requesting a list of sponsored advertisements from an advertisement server 220 to be sent to the web browser 204 executing on the client 202 for display with the search results of query processing. In particular, the search server 208 may include a search engine 210 for receiving and responding to search query requests, including retrieving, ranking, and sending search results to the web browser 204 executing on the client 202 for display. The search engine 210 may also be any type of executable software code such as a kernel component, an application program, a linked library, an object with methods, a script or other type of executable software code. The search engine 210 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. The search server 208 may be operably coupled to search server storage 212 that may store an index 214 of crawled web pages 216 that may be searched using keywords of the search query to find web pages that may be provided in the search results. The search server storage 212 may also store search result web pages 218 that provide a list of search results with addresses of web pages such as Uniform Resource Locators (URLs).

The advertisement server 220 may be any type of computer system or computing device such as computer system 100 of FIG. 1. The advertisement server 220 may provide services for providing a list of advertisements that may be sent to the web browser 204 executing on the client 202 for display with the search results of query processing. The advertisement server 220 may include an advertisement serving engine 222 that may receive a request to serve a list of advertisements for display with the search results of query processing. The advertisement serving engine 222 may include a sponsored advertisement selection engine 224 that may select the list of advertisements using a variety of features. The advertisement serving engine 222 may also include a sponsored advertisement scoring engine 226 that may score a list of advertisements using a variety of features. The advertisement server 220 may include a sequence optimizer for decision trees 228 that may optimize a sequence order of decision trees used to evaluate feature values to score advertisements. Each of these components may also be any type of executable software code such as a kernel component, an application program, a linked library, an object with methods, a script or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The advertisement server 220 may be operably coupled to a database of advertisements such as advertisement server storage 230 that may store any type of advertisements 232, including an advertisement displayed in a sponsored search area of a search results page. The advertisement server storage 230 may also store decision trees 234 used to evaluate feature values of advertisements and to score advertisements. The advertisement server storage 230 may also store a decision tree similarity matrix 236 with tree similarity values representing the number of common features between decision trees. And the advertisement server storage 230 may also store a decision tree sequence order 238 that is an optimized sequence order for evaluating decision trees of a list of advertisements to score the list of advertisements. In an embodiment, an advertisement 232 stored by the advertisement server storage 230 may be associated with an advertisement ID 240. An advertisement ID 240 associated with an advertisement 232 may be allocated to a web page placement 242 that may include a Uniform Resource Locator (URL) 244 for a web page and a position 246 for displaying an advertisement on the web page. In various embodiments, a web page may be any information that may be addressable by a URL, including a document, an image, audio, and so forth. As used herein, a web page placement may mean a location on a web page designated for placing an advertisement for display.

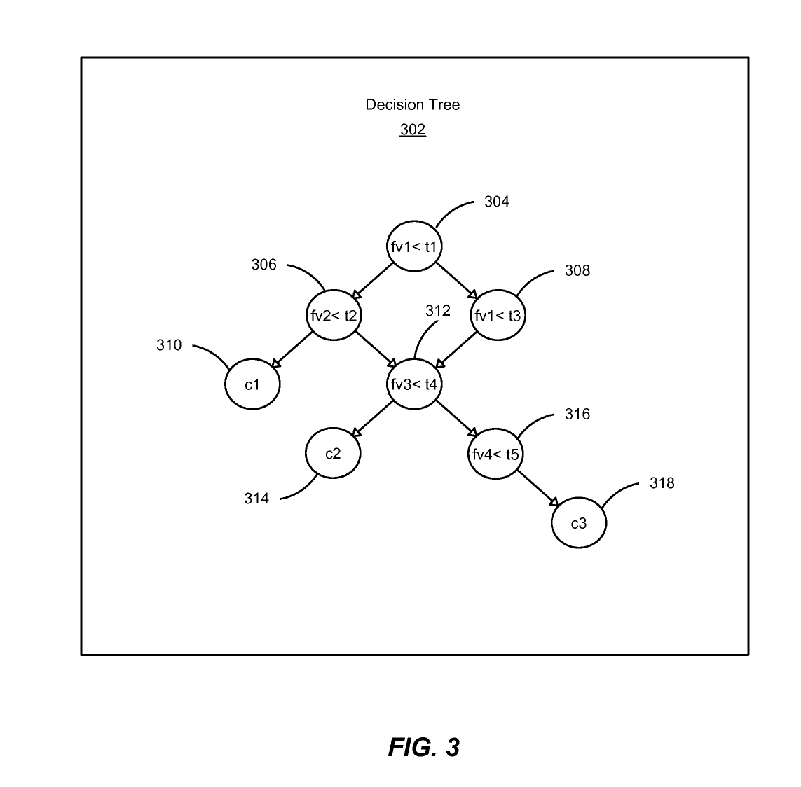

When a request may be received to serve a list of advertisements for display with the search results of query processing, the present invention may score a list of advertisements by evaluating an optimized sequence of decision trees of a list of advertisements to score the advertisements. For sponsored search advertising, for example, features may be drawn from a query, advertiser texts and its semantic content, the users' intent, a click feedback feature such as an attribute or value derived from the click history of an advertisement impression for a query-advertisement pair, and so forth. Advertisement selection may then be modeled as a serial traversal of a set of decision trees used to evaluate feature values of advertisements and to score advertisements. For example, FIG. 3 depicts in an embodiment a decision tree for scoring an advertisement. In the embodiment illustrated in FIG. 3 for example, node 304 may be a root node of the decision tree 302. Node 304 and internal nodes 306, 308, 312 and 316 may each store or reference an expression that may be used to evaluate feature values applicable to an advertisement, such as an inequality of the form, Value(Feature)<Threshold Value. For example, node 304 illustrates an expression of the form Value(Feature)<Threshold Value: fv1<t1 where fv1 may be a feature value of a feature for age, such as 26, and t1 may be a threshold such as 30. Nodes 310, 314, and 318 may be leaf nodes of the decision tree 302 that may each store or reference an expression that may be used to score an advertisement, such as an equation of the form, score=score+c. Thus, the score for an advertisement may be boosted on reaching a leaf node of a decision tree in an embodiment. The boosting value may be determined by machine learned models known in the art that may account for features such as user intent. It is important to note that a given feature may be used in multiple internal nodes of a given tree or in internal nodes of other decision trees, although the corresponding threshold values in the expressions may be different.

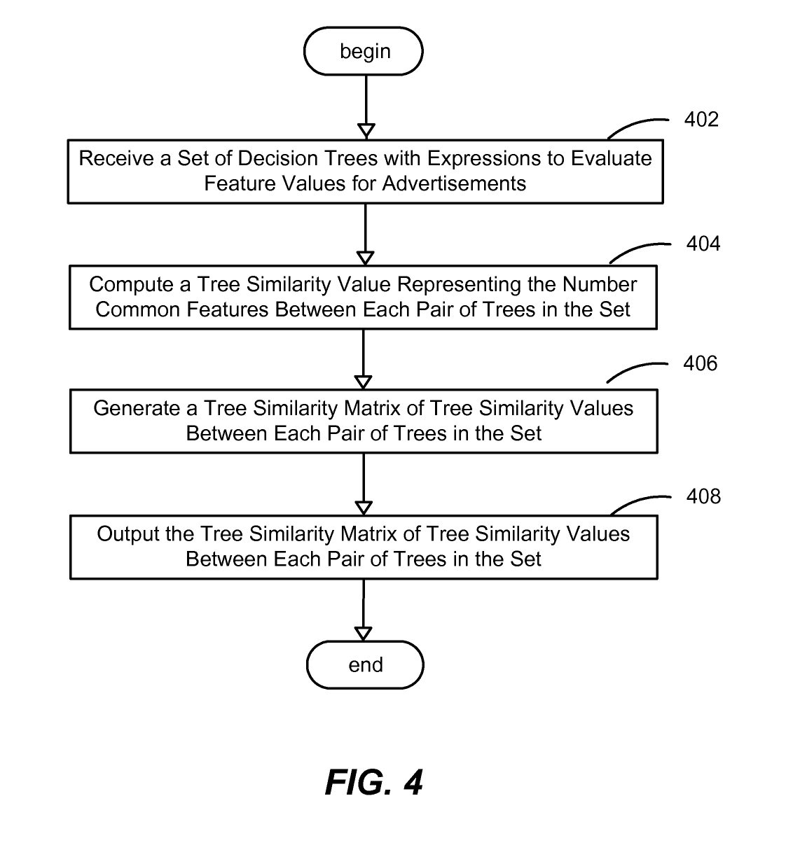

FIG. 4 presents a flowchart generally representing the steps undertaken in one embodiment for determining decision tree similarity. At step 402, a set of decision trees with expressions to evaluate feature values for advertisements may be received. At step 404, a decision tree similarity value representing the number of common features between a pair of decision trees may be calculated for each pair of decision trees in the set. In an embodiment, a similarity index between trees Tᵢ and Tⱼ may be defined as the number of features that are common to the two trees. The similarity index may be computed in an embodiment between each pair of trees Tᵢ and Tⱼ such that 1≦i≦j≦300.

At step 406, a decision tree similarity matrix of decision tree similarity values between each pair of decision trees in the set may be generated. The decision tree similarity values between each pair of decision trees may be represented by a lower triangular matrix with zero values on the diagonal. And the decision tree similarity matrix of decision tree similarity values between each pair of decision trees in the set may be output at step 408. In an embodiment, the decision tree similarity matrix may be output by storing the decision tree similarity matrix in a computer-readable storage medium.

In general, a small value of similarity index between trees Tᵢ and Tᵢ₊₁ implies that the values of the features accessed by Tᵢ are reused by Tᵢ₊₁ to a small extent. This adversely affects cache performance as the values of the features accessed by Tᵢ₊₁ will not be available in the cache. In the worst case, fetching the values of the features accessed by Tᵢ₊₁ may evict the values accessed by Tᵢ which could have been reused by tree Tᵢ₊₂ (or tree Tⱼ in general, where j>i+1), which would induce further cache misses. To reduce cache misses of feature values, the traversal order of the decision trees may be ordered such that decision trees with high similarity index are placed close to each other in order to enhance reuse of values of features accessed by consecutive trees. Thus, a traversal order of a given set of decision trees may be determined that optimizes cache performance. The ordering that optimizes cache performance may maintain semantic correctness since the order of computation may vary in boosting algorithms whose output is the sum of many decision tree functions.

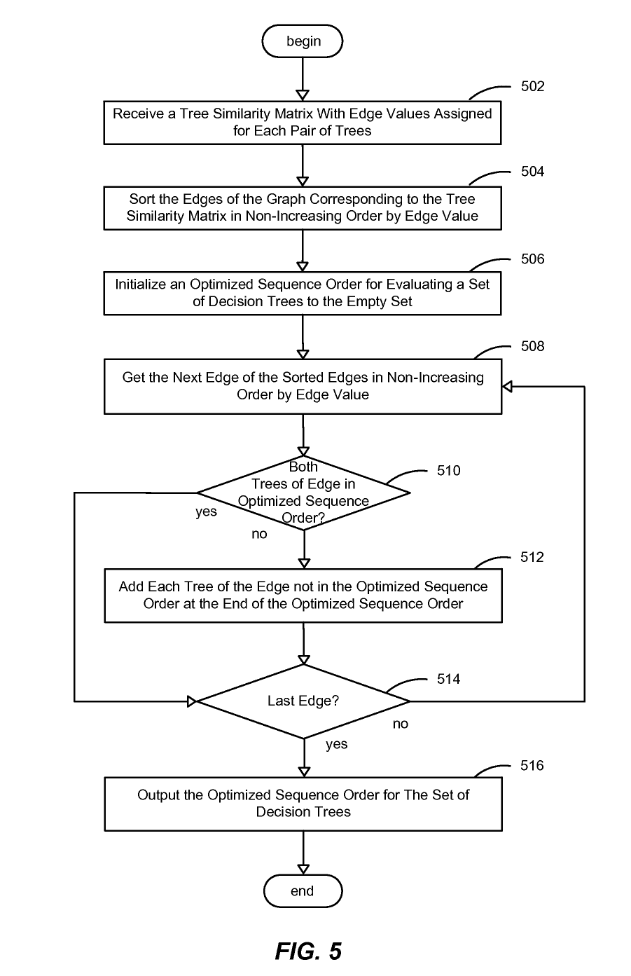

FIG. 5 presents a flowchart generally representing the steps undertaken in one embodiment for generating an optimized sequence order for evaluation of decision trees. At step 502, a decision tree similarity matrix of decision tree similarity values assigned as edge values for pair of decision trees may be received. For example, a tree similarity matrix M may represented as a fully connect graph G(V,E), where V is the set of vertices and E is set of edges in the graph G. A vertex vᵢ represents the tree Tᵢ and the weight of an edge E(Tᵢ,Tⱼ) is equal to the value M(i,j), where i<j. Thus a tree similarity matrix M may have four trees, T₀, T₁, T₂, and T₃ with tree similarity values of E(T₀,T₁)=2, E(T₀,T₂)=3, E(T₀,T₃)=7, E(T₁,T₂)=4, E(T₁,T₃)=6, and E(T₂,T₃)=1.

At step 504, the edges between pairs of decision trees in the decision tree similarity matrix may be sorted in non-increasing order by edge values. The edges of tree similarity matrix, M, in the example above, has the following non-increasing sorted order: E(T₀,T₃)=7, E(T₁,T₃)=6, E(T₁,T₂)=4, E(T₀,T₂)=3, E(T₀,T₁)=2, E(T₂,T₃)=1. At step 506, a set of decision trees in an optimized sequence order for evaluation may be initialized to the empty set. For example, the set N may be initialized as N={ }. And, at step 508, the first edge may be obtained for a pair of decision trees from the edges sorted in non-increasing order by edge value. The edge E(T₀,T₃)=7 in the example would be the first edge obtained for a pair of decision trees from the edges sorted in non-increasing order by edge value.

It may be determined at step 510 whether both decision trees of the edge belong to the set of decision trees in an optimized sequence order for evaluation. If both decision trees of the edge do not belong to the set of decision trees in an optimized sequence order for evaluation, then each decision tree of the edge that does not belong to the set of decision trees in an optimized sequence order for evaluation may be added at step 512 to the set of decision trees in an optimized sequence order for evaluation and processing may continue at step 514 where it may be determined whether the last edge from the edges sorted in non-increasing order by edge value has been processed. For the edge E(T₀,T₃)=7 in the example, neither of the decision trees T₀ and T₃ belong to the set of decision trees in an optimized sequence order that was initialized as N={ }. So both decision trees would be added to the set of decision trees in an optimized sequence order, resulting in N={T₀,T₃}. For the next edge E(T₁,T₃)=6, only decision tree T₁ would be added since T₃ already belongs to the set of decision trees in an optimized sequence order, resulting in N={T₀,T₃,T₁}. Similarly for the next edge E(T₁,T₂)=4, only decision tree T₂ would be added since T₁ already belongs to the set of decision trees in an optimized sequence order, resulting in N={T₀,T₃,T₁,T₂}.

Returning to FIG. 5, otherwise, if it may be determined at step 510 that both decision trees of the edge belong to the set of decision trees in an optimized sequence order for evaluation, then it may be determined at step 514 whether the last edge from the edges sorted in non-increasing order by edge value has been processed. If not, then processing may continue at step 508 where the next edge may be obtained for a pair of decision trees from the edges sorted in non-increasing order by edge value. Thus, for the last three edges in the example, E(T₀,T₂)=3, E(T₀,T₁)=2, E(T₂,T₃)=1, both of the decision trees for each of these last three edges already belong to the set of decision trees in an optimized sequence order, so there are no other decision trees added from these last three edges to the set of decision trees in an optimized sequence order, N={T₀,T₃,T₁,T₂}.

If it may be determined at step 514 that the last edge from the edges sorted in non-increasing order by edge value has been processed, then the set of decision trees in an optimized sequence order for evaluation may be output at step 516. In an embodiment, the set of decision trees in an optimized sequence order for evaluation may be output by storing the set of decision trees in an optimized sequence order for evaluation in a computer-readable storage medium.

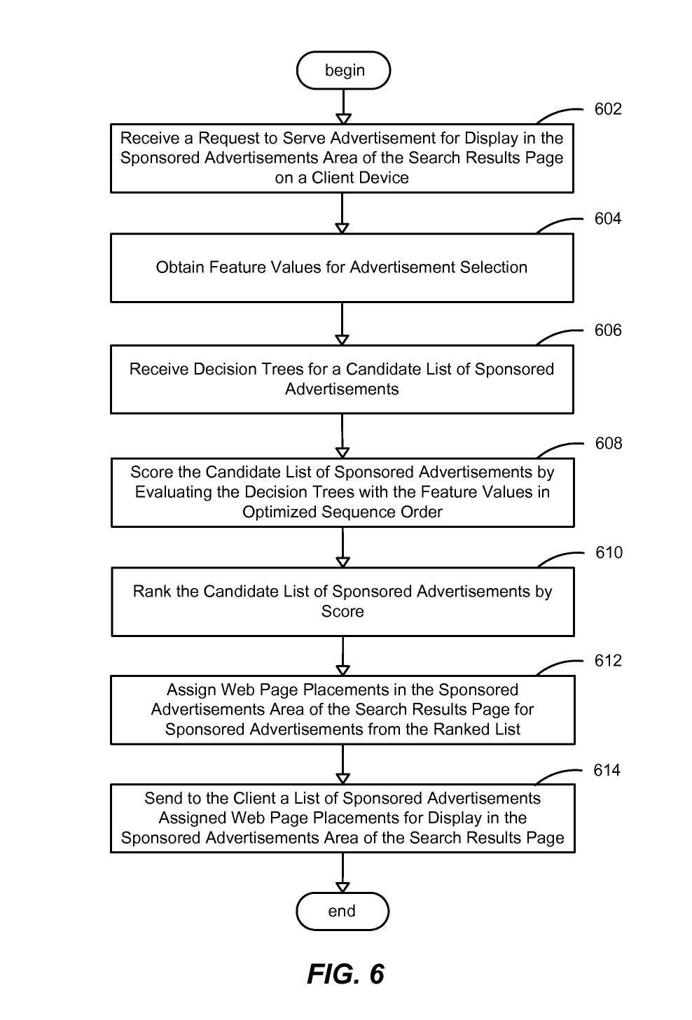

FIG. 6 presents a flowchart generally representing the steps undertaken in one embodiment on an advertisement server for selecting advertisements by evaluating an optimized sequence of decision trees of advertisements to score the advertisements. At step 602, a request may be received to serve advertisements for display in a sponsored advertisements area of a search results page on a client device. And feature values may be obtained at step 604 for advertisement selection. For instance, the advertisement server may obtain features of the query, advertiser texts and its semantic content, the users' intent, click feedback, and so forth.

At step 606, decision trees for a candidate list of sponsored advertisements may be received, and the candidate list of sponsored advertisements may be scored at step 608 by evaluating the decision trees in the optimized sequence order using the feature values. At step 610, the candidate list of sponsored advertisements may be ranked by score. And sponsored advertisement from the ranked list may be assigned web page placements in the sponsored advertisements area of the search results page at step 612. In an embodiment, the highest scoring sponsored advertisements from the ranked list of sponsored advertisements are assigned to the available web page placements in order by highest score. And the list of sponsored advertisements assigned web page placements for display in the sponsored advertisements area of the search results page may be sent to a client device at step 614.

Thus the present invention may optimize ranking advertisements by exploiting decision tree similarity to improve the run time memory performance by reducing the number of cache misses, a dominant component of the CPU inefficiency. Advantageously, the optimizations performed are decoupled from the techniques developed for evaluation of user intent and understanding the query semantics. Specifically, a set of decision trees may be input and an optimized ordering of decision trees may be output. Moreover, reducing latency in advertisement selection by optimizing the serial traversal order of decision trees facilitates deployment of advanced ranking techniques employing an increased number of dimensions of features and metrics for evaluating an advertisement's rank to provide more relevant advertisements. Accordingly, the effectiveness of advertisement selection can be increased up to thousands of trees, so that optimization benefits of the present invention will scale to support advertisement selection performed over a cluster comprising of tens of thousands of computing nodes.

As can be seen from the foregoing detailed description, the present invention provides an improved system and method for optimizing selection of online advertisements. A decision tree similarity matrix of decision tree similarity values between pairs of decision trees may be generated that represent the number of common features between two decision trees. The edges of the decision tree similarity matrix may be sorted in non-increasing order by edge value, and the decision trees of each edge retrieved from the sorted order may be placed in an optimized sequence order for evaluation. By placing decision trees with high similarity close to each other in a traversal order for evaluation, feature values in cache may be accessed by consecutive decision trees with fewer cache misses. Thus the present invention may optimize ranking advertisements by exploiting decision tree similarity to improve the run time memory performance for evaluating decision trees to score advertisements. As a result, the system and method provide significant advantages and benefits needed in contemporary computing and in search advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for selecting advertisements, comprising:
a sponsored advertisement selection engine that selects one or more sponsored advertisements from a plurality of sponsored advertisements scored by evaluating a plurality of decision trees in an optimized sequence order;
a sponsored advertisement scoring engine operably coupled to the sponsored advertisement selection engine that scores the plurality of sponsored advertisements by evaluating the plurality of decision trees in the optimized sequence order; and
a storage operably coupled to the sponsored advertisement scoring engine that stores the plurality of decision trees for the plurality of sponsored advertisements and that stores the optimized sequence order for evaluating the plurality of decision trees for the plurality of sponsored advertisements.

2. The system of claim 1 further comprising an advertisement serving engine operably coupled to the sponsored advertisement selection engine that serves the one or more sponsored advertisements from the plurality of sponsored advertisements scored by evaluating the plurality of decision trees in the optimized sequence order.

3. The system of claim 1 further comprising a sequence optimizer operably coupled to the sponsored advertisement selection engine that generates the optimized sequence order for evaluating the plurality of decision trees for the plurality of sponsored advertisements.

4. The system of claim 2 further comprising a web browser operably coupled to the advertisement serving engine that displays the one or more sponsored advertisements from the plurality of sponsored advertisements scored by evaluating the plurality of decision trees in the optimized sequence order.

5. A computer-implemented method for selecting advertisements, comprising:
receiving a plurality of decision trees for a plurality of sponsored advertisements;
evaluating the plurality of decision trees for the plurality of sponsored advertisements in a sequence order optimized by feature similarity between the plurality of decision trees;
assigning a score to the plurality of sponsored advertisements from evaluating the plurality of decision trees for the plurality of sponsored advertisements in the sequence order optimized by feature similarity between the plurality of decision trees;
assigning at least one sponsored advertisement of the plurality of sponsored advertisements with a highest score to at least one web page placement in a sponsored advertisements area of the search results web page; and
sending the at least one sponsored advertisement for display on the search results web page in a location of the at least one web page placement in the sponsored advertisement area of the search results web page.

6. The method of claim 5 further comprising storing the at least one sponsored advertisement for display on the search results web page in the location of the at least one web page placement in the sponsored advertisement area of the search results web page.

7. The method of claim 5 further comprising receiving the sequence order optimized by feature similarity between the plurality of decision trees.

8. The method of claim 5 further comprising receiving a plurality of feature values for advertisement selection.

9. The method of claim 5 further comprising receiving the sequence order optimized by feature similarity between the plurality of decision trees.

10. The method of claim 5 further comprising ranking the plurality of sponsored advertisements in order by the score assigned to the plurality of sponsored advertisements from evaluating the plurality of decision trees for the plurality of sponsored advertisements in the sequence order optimized by feature similarity between the plurality of decision trees.

11. The method of claim 5 further comprising receiving by a client device the at least one sponsored advertisement for display on the search results web page in the location of the at least one web page placement in the sponsored advertisement area of the search results web page.

12. The method of claim 5 further comprising displaying by a client device the at least one sponsored advertisement in the location of the at least one web page placement in the sponsored advertisement area of the search results web page.

13. The method of claim 5 further comprising optimizing the plurality of decision trees for the plurality of sponsored advertisements in a sequence order by feature similarity between the plurality of decision trees.

14. The method of claim 13 further comprising calculating a plurality of tree similarity values each representing a number of common features between pairs of the plurality of decision trees.

15. The method of claim 14 further comprising generating a tree similarity matrix of the plurality of tree similarity values each representing the number of common features between the plurality of pairs of the plurality of decision trees.

16. The method of claim 15 further comprising adding each of the plurality of decision trees represented by a plurality of edges from the tree similarity matrix in non-increasing order by tree similarity value to the sequence order.

17. The method of claim 15 further comprising storing the sequence order on a computer-readable storage medium.

18. A computer-readable storage medium having computer-executable instructions for performing the method of claim 5.

19. A computer system for selecting advertisements, comprising:
means for receiving a plurality of decision trees for a plurality of advertisements;
means for optimizing a sequence order for evaluation of the plurality of decision trees for the plurality of advertisements; and
means for outputting the sequence order for evaluation of the plurality of decision trees for the plurality of advertisements.

20. The computer system of claim 19 further comprising means for selecting at least one of the plurality of advertisements from evaluation of the plurality of decision trees for the plurality of sponsored advertisements in the sequence order, and
means for sending the at least one of the plurality of advertisements for display on a client device.
